(19) United States
(12) Patent Application Publication
(10) Pub. No.: US 2014/0081848 A1
(43) Pub. Date: Mar. 20, 2014

(54) METHOD FOR ELECTRONICALLY PROCESSING A TRAFFIC OFFENSE AND ONBOARD-UNIT THEREFOR

(71) Applicant: Kapsch TrafficCom AG, Vienna (AT)

(72) Inventors: Alexander Leopold, Wien (AT); Robert Povolny, Wien (AT); Oliver Nagy, Wien (AT)

(73) Assignee: Kapsch TrafficCom AG, Vienna (AT)

(21) Appl. No.: 14/023,917

(22) Filed: Sep. 11, 2013

(30) Foreign Application Priority Data
Sep. 17, 2012 (EP) 12184677.8

(51) Int. Cl. G06Q 20/32

(52) U.S. Cl. CPC G06Q 20/327
USPC 705/39

(57) ABSTRACT

A method for electronically processing a traffic violation of a vehicle that comprises an onboard unit having a transceiver, an input device and an output device, and an onboard unit for carrying out the method, are provided. The method includes: transmitting a traffic violation message from a beacon to the transceiver of the onboard unit and outputting the traffic violation message on the output device of the onboard unit; accepting a user selection concerning two options via the input device of the onboard unit; if the user selection indicates the first option, transmitting the traffic violation message from the onboard unit to a remote central facility; if the user selection indicates the second option, generating a debit transaction related to the traffic violation and charging the debit transaction against a user account.

### CROSS-REFERENCE TO RELATED APPLICATION(S)

This application claims priority to European Patent Application No. 12 184 677.8, filed on Sep. 17, 2012, the entirety of which is incorporated by reference herein.

### BACKGROUND

1. Technical Field

The present patent application relates to a method for electronically processing a traffic violation of a vehicle, which comprises an onboard unit having a transceiver, an input device and an output device. The present patent application further relates to an onboard unit for carrying out this method.

2. Background Art

Onboard units (OBUs) are electronic devices carried by vehicles so as to be able to identify the vehicles in a wireless manner, for example for the purpose of billing tolls in electronic road toll systems. OBUs can be implemented in the form of active or passive radio transponders, radio frequency identification (RFID) chips, near field communication (NFC) chips, dedicated short range communication (DSRC) transceivers for radio or infrared data transmission, wireless access in vehicular environments (WAVE) and wireless local area network (WLAN) nodes, or the like.

### BRIEF SUMMARY

It is an object of the present patent application to render such OBUs usable for processing traffic violations such as speed limit violations, parking time violations or the like. In a first aspect, this object is achieved by a method for electronically processing a traffic violation of a vehicle, which comprises an onboard unit having a transceiver, an input device and an output device, comprising:

transmitting a traffic violation message from a beacon to the transceiver of the onboard unit and outputting the traffic violation message on the output device of the onboard unit;

accepting a user selection concerning two options via the input device of the onboard unit;

if the user selection indicates the first option, transmitting the traffic violation message from the onboard unit to a remote central facility;

if the user selection indicates the second option, generating a debit transaction related to the traffic violation and charging the debit transaction against a user account.

Embodiments allow traffic enforcement officials, such as law enforcement officers, policemen, parking enforcement officers, parking space managers and the like, to write a detected traffic violation, such as a speed limit or parking time violation, directly to the onboard unit of the violating vehicle in the form of an electronic traffic violation message by a beacon that is implemented as a handheld device, for example, using radio or infrared. The vehicle user receives the violation message on the onboard unit via voice output or graphic display and can then decline or accept the violation via the input device. In the first case, the traffic violation message is forwarded to a central facility for conventional violation processing, for example so as to print and mail a penalty notice to the user, who may then also lodge an appeal. In the second case, if the user accepts the violation, the user can immediately pay the fine with the aid of the onboard unit in that the onboard unit generates a corresponding debit transaction and charges it against a user account or at least initiates this step.

It shall be noted here that an onboard processing unit is known from the document U.S. Pat. No. 6,163,277, which, after analyzing data received via vehicle sensors and road-side signboards, detects speeding violations of the vehicle and, with appropriate severity of the violation, automatically contacts the police, who can then read out the violation data from the processing unit. The police officer can then establish separate voice communication with the vehicle driver and offer to have the vehicle driver pick up the ticket or to have it mailed.

The user selection made by the user can be confirmed by entering a PIN code so as to increase system security; this can prevent unauthorized persons from confirming or declining a traffic violation, for example.

It is also favorable if a cryptographic signature of the OBU is transmitted together with the traffic violation message, and in particular if the OBU signs and/or encrypts the traffic violation message with a cryptographic signature. Authenticated data can thus be generated for penalty notices, offering maximum legal safeguards.

According to an embodiment, the user selection can be made in particular by way of an NFC connection in the input device. For example, a mobile telephone, smartphone, PDA, tablet PC or the like having an NFC chip can be used as the input device (and also as the output device), and the user selection can be made by this device approaching an OBU that is integrated in or mounted on the vehicle. In this way, for example, the user selection can be set to the second option, this being the confirmation of the violation and generation of a debit transaction, simply by the device approaching the unit.

The actual debit against the user account can take place in a wide variety of ways, depending on where the user account is kept. If, according to a first embodiment, the user account is kept directly in the onboard unit, the onboard unit can also directly generate the debit transaction and carry out a corresponding debit against the user account. If an NFC-compatible input device is used, the user account can also be kept on a data carrier, which is debited by way of such an NFC connection. For example, one of the above devices, these being mobile telephone, smartphone or the like, can be used as the input device, the NFC connection can be established by the device approaching the remaining OBU part and, for example, a payment transaction for the data carrier can be generated in this device or sent to the mobile communication network via a mobile communication connection and the debit transaction can be charged against a user account there.

If the user account is kept in the central facility, the onboard unit can, for example, transmit the traffic violation message together with the user selection to the central facility, so that the debit transaction is charged there against the user account. As an alternative, if the user account is kept in the central facility, the onboard unit can transmit a completed debit transaction to the central facility, which is then applied there to the user account.

An advantageous embodiment is characterized by the preceding step of transmitting a status of the onboard unit to the beacon and creating the traffic violation message in the beacon depending on the received status. For example, the status of the onboard unit can relate to an operating mode of the onboard unit and/or of the vehicle, such as standstill or movement, speed, operating mode, “parking”, the readiness to pay a particular parking fee, claiming a particular priority, for example emergency vehicle, multi-occupant status for so-called high occupancy vehicle (HOV) lanes, the result of an earlier toll transaction, parking fee transaction or vehicle inspection or the like. Depending on the status that is read out from the onboard unit, the inspecting officer can compile the corresponding traffic violation message on the beacon or the beacon can generate it automatically, for example based on its own control measurements on the vehicle or the OBU, and can write the violation message to the OBU.

The communication between the beacon and onboard unit may take place according to the dedicated short range communication (DSRC) standard, for example the CEN-DSRC standards using radio or infrared data transmission, ITS-G5, IEEE 802.11p, wireless local area network (WLAN), wireless access in vehicular environments (WAVE), radio frequency identification (RFID), near field communication (NFC), or the like.

In a second aspect, an onboard unit is created for a vehicle, comprising a transceiver, an input device and an output device, which is configured

to receive a traffic violation message from a beacon and output it on the output device;

accept a user selection concerning two options via the input device;

if the user selection indicates the first option, transmit the traffic violation message to a remote central facility; or

if the user selection indicates the second option, to initiate the generation of a debit transaction for a user account related to the traffic violation.

The onboard unit may comprise a stored modifiable status and is configured to transmit the status via the transceiver to the beacon in response to a wireless poll. The onboard unit may be configured to keep a user account and charge the debit transaction against the same.

Reference is made to the above comments regarding the method in terms of the advantages and characteristics of the onboard unit.

### BRIEF DESCRIPTION OF THE DRAWINGS/FIGURES

Embodiments will be described in greater detail hereafter with reference to the accompanying drawings. In the drawings:

FIG. 1 shows a schematic overview of the communication of an onboard unit in the tolling mode with tolling beacons on their way on a road, according to an example embodiment.

FIG. 2 shows a schematic overview of the communication of onboard units in the parking mode with a parking beacon during parking, according to an example embodiment.

FIG. 3 is a block diagram and FIG. 4 is a front view of an exemplary onboard unit according to an embodiment.

FIG. 5 is a state transition diagram of a part of a method for generating parking fee transactions that is carried out in an onboard unit, according to an example embodiment.

FIG. 6 is a flow chart of a part of a method for generating parking fee transactions that is carried out in a parking beacon, according to an example embodiment.

FIG. 7 is a schematic illustration of a road traffic check, during the course of which a part of the method is carried out, according to an example embodiment.

FIG. 8 shows a method embodiment in the form of the signal flows between the components involved in the method.

Embodiments will now be described with reference to the accompanying drawings.

### DETAILED DESCRIPTION

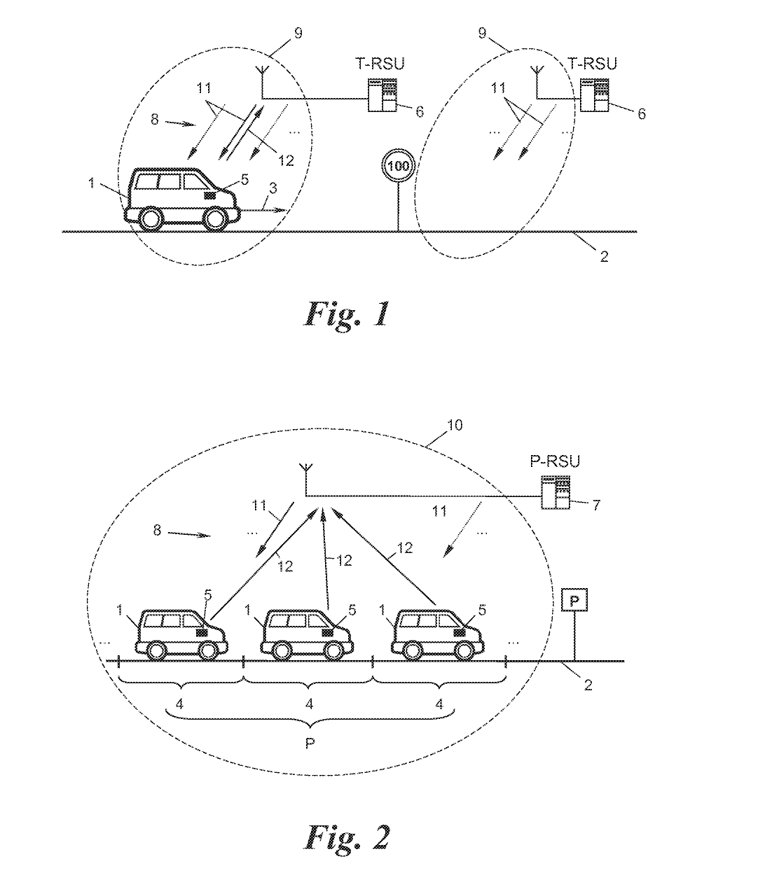

In FIG. 1, a vehicle 1 is moving on a road 2 at a speed and in a driving direction 3, and in FIG. 2 several vehicles 1 are parked in each case in a parking space 4 of the road 2. The road 2 can be any arbitrary traffic or parking area, for example an expressway, a highway or an entire road system in FIG. 1, or a shoulder, a large parking space or a parking garage in FIG. 2; all of these are considered to be covered by the general concept of “road” 2.

Each of the vehicles 1 is equipped with an onboard unit (OBU) 5, which is able to carry out wireless communication 8 with roadside beacons (roadside units, RSUs) 6, 7. The OBUs 5 can be separate devices or an integral part of the vehicle electronics system. The communication 8 is short range or dedicated short range communication (DSRC), which may be configured according to the CEN-DSRC standards using radio or infrared data transmission, ITS-G5, IEEE 802.11p, WAVE, WLAN, RFID, NFC or the like. The beacons 6, 7 thus have a respective locally delimited radio or infrared coverage range 9, 10.

FIGS. 1 and 2 show two different types of beacons 6, 7 and application scenarios of the described components. The beacons 6 of FIG. 1 are “tolling” beacons (tolling roadside units, T-RSUs) that are set up in a geographically distributed manner along the road 2. With the aid of periodically broadcast polls 11, the tolling beacons 6 request all passing OBUs 5 to establish communication 8, as is illustrated based on the exemplary response 12. So as not to “miss” any passing OBU 5 due to the potentially high speed of the vehicle 1, the polls 11 of the tolling beacons 6 are broadcast at relatively short intervals, for example every 100 ms or less. For the polls 11, for example, so-called wave service announcement (WSA) messages are used in the WAVE standard, and so-called beacon service table (BST) messages are used in the CEN-DSRC standard.

Successful communication 8 with a passing OBU 5 demonstrates that the OBU 5 is located in the locally delimited coverage range 9 of the tolling beacon 6, whereby a fee (“toll”) can be charged for usage of the location of the tolling beacon 6. For example, the tolled location usage can be the driving on a road section, the entering of a particular territory (“city toll”) or the like.

In contrast, “parking” beacons (parking roadside units, P-RSUs) 7 are employed in the parking scenario of FIG. 2, which use a poll 11, for example a WSA or BST message, to request all the OBUs 5 located in the coverage range 10 to provide response messages 12 so as to charge a fee for the usage of the parking spaces 4, as will be described in greater detail hereafter. To this end, a parking beacon 7 may be in charge of one or more parking spaces 4, which together form a parking area P.

Because parked vehicles 1 are stopped, a parking beacon 7 can broadcast its polls 11 at considerably longer time intervals ΔT than the tolling beacon 6 of FIG. 1, for example every 10 minutes, which also defines the time resolution of the parking time billing.

The coverage range 10 of the parking beacon 7 can be adapted to the spatial expansion of the parking spaces 4 using optional measures, for example directional antennas, so as to avoid responses 12 of OBUs 5 of vehicles 1 that are not parked, for example passing vehicles. As an alternative or in addition, the OBUs 5 of the vehicles 1 can also be caused to assume different operating modes, which are adapted in each case to the scenarios of FIGS. 1 and 2, and more particularly a first toll operating mode (tolling mode, TM) for responses 12 to polls 11 from tolling beacons 6, and a second parking operating mode (parking mode, PM) for responses 12 to polls 11 from parking beacons 7. In the polls 11, the beacons 6, 7 can optionally broadcast a respective beacon identifier, which indicates whether it is a tolling beacon 6 or a parking beacon 7. The beacon identifier can, for example, be indicated as a service of the beacon as part of a WSA or BST message.

Of course, the tolling beacons 6 and parking beacons 7 can also be implemented by one and the same physical unit, which alternately or simultaneously performs the functions of a tolling beacon and a parking beacon 6, 7. Such a combined unit 6, 7 can thus broadcast polls 11 with the beacon identifier of a tolling beacon, for example continually at short intervals, and polls 11 with the beacon identifier of a parking beacon 7 at longer intervals ΔT, which is to say occasionally “interspersed”. Such a beacon 6, 7 is then in charge of both charging a toll for a road section of the road 2 and charging a fee for a parking area P, for example.

Depending on the operating mode TM or PM of the OBU 5, and depending on the received beacon identifier, the OBU 5 can, for example, respond only to tolling beacons 6 if the OBU is in the tolling mode TM or only to parking beacons 7 if the OBU is in the parking mode PM.

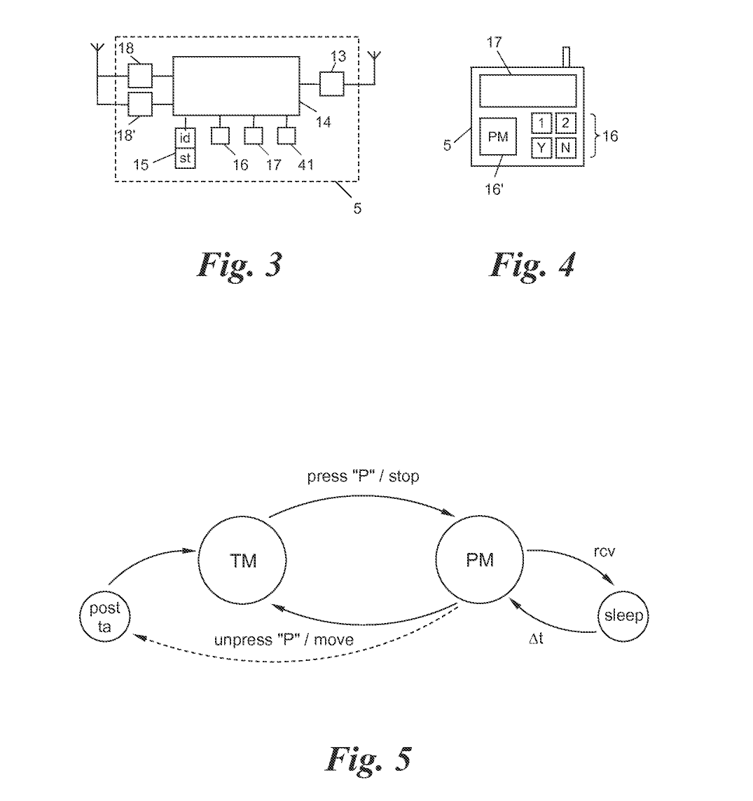

The operating mode of an OBU 5 can further be encoded as a data message (status) st and transmitted as part of the response 12. A beacon 6, 7 can appropriately evaluate the status st received in a response 12, so that tolling beacons 6 only charge tolls for the passage of OBUs 5 where status st=TM, and parking beacons 7 only charge fees for the parking of those OBUs 5 where status st=PM. Moreover, the OBUs 5 can also measure their own respective positions p and transmit these to the parking beacons 7, which compare the received positions p to the respective parking areas P and only charge fees for the parking of those OBUs 5, the positions p of which are within the respective parking area P. This will be described in more detail hereafter with reference to FIGS. 3 to 6.

FIG. 3 shows an exemplary block diagram, FIG. 4 shows an exemplary outside view, and FIG. 5 shows an exemplary state transition diagram of an OBU 5, which can be switched between (at least) two operating modes TM and PM in accordance with the application scenarios of FIGS. 1 and 2. According to FIG. 3, to this end an OBU 5 comprises a transceiver 13 (for example according to one of said DSRC standards) for carrying out the communication 8, a microprocessor 14 controlling the transceiver 13, a memory 15, an input device 16, and an output device 17. The input and output devices 16, 17 can also be implemented in a manner that differs from the shown keyboard and monitor output, for example by way of voice input and output, sensor systems, advisory tones and the like. The input and output devices 16, 17 can also be formed by physically separate components such as car radios, navigation devices, smartphones, PDAs, tablets and the like and can be connected to the microprocessor 14 by wire or wirelessly, for example by way of NFC, Bluetooth®, WLAN or infrared.

The OBU 5 can optionally also comprise a movement sensor 18, for example in the form of a satellite navigation receiver for a global navigation satellite system (GNSS), such as GPS, GLONASS, GALILEO and the like; instead of a GNSS receiver, it is also possible to use any other type of movement sensor 18, for example an inertia sensor (inertial measurement unit, IMU) or a sensor that is connected to components of the vehicle 1, for example a connection to the speedometer or engine of the vehicle 1.

In the simplest case, the movement sensor 18 can also be only a connection to the vehicle electronics system, for example the ignition lock of the vehicle, so that the position of the key (engine running—not running), for example, indicates the (anticipated) movement or parking status of the vehicle.

The OBU 5 can optionally also be equipped with a position determination device 18′, which is able to determine the current position p of the OBU 5—in response to a poll, periodically or continuously. The position determination device 18′ can operate in any manner that is known in the art, for example by way of radio triangulation in a network of geographically distributed radio stations, which can be formed directly by the beacons 6, 7 or by base stations of a mobile communication network, for example, or by way of evaluation of the cell identifiers of a cellular mobile communication network, and the like. The position determination device 18′ may be a satellite navigation receiver for position determination in a GNSS and in particular can also be formed by the same GNSS receiver that is used for the movement sensor 18.

In addition to the appropriate application and control programs and data, the memory 15 of the OBU 5 includes a unique identifier id of the OBU 5, which is established and saved, for example, during the output or user-specific initialization of the OBU 5 and which uniquely identifies the OBU 5 and/or the user thereof and/or the vehicle 1 and/or a settlement account of the user. The OBU identifier id is transmitted together with every response message 12 from the OBU 5 to a beacon 6, 7 so as to uniquely identify the OBU 5 with respect to the beacon 6, 7.

The memory 15 can further include the status st, which indicates the operating mode TM or PM of the OBU 5 for the corresponding scenario of FIG. 1 or 2. The status st can be modified or adjusted both depending on a movement (or non-movement) of the OBU 5 measured by the movement sensor 18 or by a user selection via the input device 16. For this purpose, the input device 16 may, for example, comprise a lockable button 16′ (FIG. 4), which is labeled “PM” for “parking mode” PM and switches the OBU 5 to the parking mode PM by pressing and locking and sets the status st to the value “PM”. The OBU 5 is reset to the tolling mode TM and the status st is set to the value “TM” by releasing or unlocking the button 16′. The output device 17 can optionally output appropriate advisory and/or confirmation messages.

FIG. 5 shows several of the possible operating states of the OBU 5 again in detail in the form of a state transition diagram. The OBU 5 can be switched from the tolling mode TM into the parking mode PM by pressing the button 16′ and/or if the movement sensor 18 determines no movement of the OBU 5 over a minimum time period for 5 minutes, for example. The OBU can be set from the parking mode PM back to the tolling mode TM by releasing the button 16′ and/or by a movement of the OBU 5 detected by the movement sensor 18.

In the parking mode PM, the OBU 5 can temporarily assume a power-saving sleep mode (“sleep”), and more particularly as soon as it has received a poll 11 from a parking beacon 7 and sent a response 12. The OBU 5 can also wake up from the sleep mode after a predetermined time period Δt has lapsed and return to the parking mode PM. The time period Δt may be shorter than the time period Δt between consecutive wireless polls 11 of a parking beacon 7. As an alternative or in addition, the OBU 5 could also be awakened again by receiving a subsequent wireless poll 11.

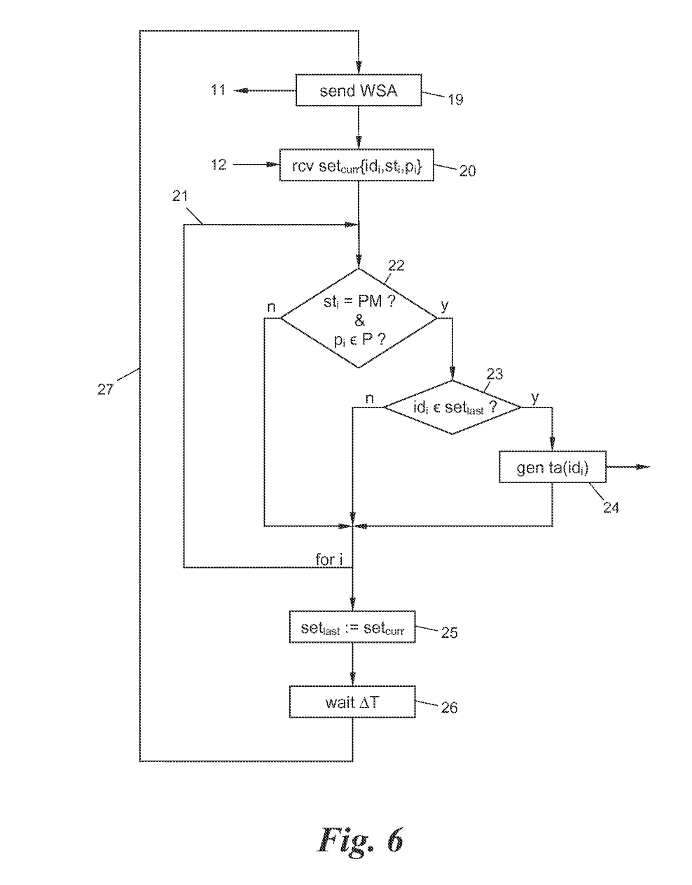

FIG. 6 shows the method for generating parking fee transactions in the application scenario of FIG. 2 that is being carried out in a parking beacon 7 in cooperation with the OBU 5 of FIGS. 3 to 5.

In a first step 19, a poll 11 is broadcast by the parking beacon 7 so as to request the OBUs 5 located in the coverage range 10 to provide responses 12. In step 20, the responses 12 arriving from the OBUs 5 are received, wherein each response 12 includes at least the respective identifier idᵢ of the OBU 5 with the index i and—optionally—the status stᵢ thereof and/or the position pᵢ thereof determined by the position determination device 18′. The received identifiers idᵢ statuses stᵢ and positions pᵢ are temporarily stored in the parking beacon 7 as a current dataset set_{curr}.

Thereafter, a check is carried out within a loop 21 covering all received identifiers idᵢ as to whether or not the respective status stᵢ is set to the parking mode “PM”, see decision 22. In addition (or as an alternative), it can be checked in the decision 22 whether or not the respective position pᵢ—provided this was transmitted—falls within a predetermined geographical region, more particularly the parking area P of the parking beacon 7. If only some of the conditions that are checked in decision 22 are met (branch “n” of 22), the subsequent steps 23 and 24 are skipped and the loop 21 is continued or exited for step 25 upon completion. In contrast, if all the conditions are met, which is to say in the present case: stᵢ=PM and pᵢ ε P (branch “y” of 22), it is checked in a further decision 23 whether the respective identifier idᵢ corresponds to a previously stored “old” identifier id_{i, last}, which is to say whether or not it occurs in a dataset setₗₐₛₜ{id_{i, last}} of old identifiers id_{i, last}. These “old” identifiers id_{i, last} were determined during an earlier execution of the method and stored in the dataset setₗₐₛₜ, as will be described hereafter.

If the respective current identifier idᵢ does not agree with any old identifier id_{i, last}, which is to say does not occur in the dataset setₗₐₛₜ (branch “n” of 23), the loop 21 is continued or exited for step 25 after it is completed; if there is agreement (branch “y” of 23), the method branches to step 24, in which a parking fee transaction ta(idᵢ) is generated for the current identifier idᵢ, as will described in greater detail later.

After step 24, the loop 21 is continued or, after completion thereof, a transition is made to step 25.

In step 25, the current identifiers idᵢ determined in step 20 are resaved as “old” identifiers id_{i, last}, which is to say the current dataset set_{curr} is (now) stored as an “old” dataset setₗₐₛₜ.

Thereafter, in step 26, a wait is carried out for the predefined time period ΔT, which is between the individual polls 11 of the parking beacon 7, and then the method is repeated (loop 27).

During the next repetition in the loop 27, the previously determined current identifiers idᵢ now constitute the “old” identifiers id_{i, last}, and if in step 20 again “new” current identifiers idᵢ are determined, these can then be compared in step 23 to the “old” identifiers id_{i, last} from the last dataset setₗₐₛₜ. As a result, it is checked during each loop execution 27 whether or not an OBU identifier idᵢ determined by a parking beacon 7 based on a poll 11 was already present during a poll 11 dating back by the time period ΔT; if so, a vehicle 1 comprising an OBU 5 having this identifier has obviously spent at least the time period ΔT in the coverage range 10 of the parking beacon 7, so that a corresponding parking fee transaction ta(idᵢ) can be generated for the OBU identifier idᵢ for parking over the time period ΔT (step 24).

The parking fee transactions ta(idᵢ) generated in step 24 can be settled directly by the beacon 7, for example by charging these to a user account that is kept in the beacon 7. Alternatively, the parking fee transactions ta(idᵢ) can be forwarded by the beacon 7 to a remote central facility (not shown), which keeps user accounts, toll accounts, bank accounts, credit accounts and the like under the identifiers idᵢ so that the parking fee transactions ta(idᵢ) can be charged there against a corresponding settlement account. However, it is also possible for the generated parking fee transaction(s) ta(idᵢ) to be returned from the beacon 7 to the OBU 5 with the identifier idᵢ and to be charged there against a settlement account (an “electronic purse”) that is kept in the OBU 5.

Another option is to temporarily store the parking fee transaction(s) ta(idᵢ) returned from the parking beacon 7 to the OBU 5 in the OBU 5 and, when the OBU 5 returns to the tolling mode TM, have the OBU 5 send it/them to a tolling beacon 6 on the way for settlement purposes, as if it were a toll transaction. FIG. 5 shows a corresponding operating mode “post ta”, which the OBU 5 temporarily assumes after returning from the parking mode PM and in which it awaits the next tolling beacon 6 on the way, so as to deliver the parking fee transaction(s) ta(idᵢ) to the same, whereupon the OBU again returns to the “normal” tolling mode TM.

The procedures shown in FIG. 6 can, of course, be appropriately modified according to programming methods known to a person skilled in the art. For example, the decision 22 could be eliminated or included in step 20, and it could be checked whether the status stᵢ of an identifier idᵢ is set to “PM” and/or the position pᵢ of an identifier idᵢ falls in the area P, wherein then only those identifiers idᵢ where status stᵢ=“PM” or position pᵢ ε P, are stored as current identifiers in the current dataset set_{curr}. The loop 21 could also be implemented differently and, for example, steps 22 to 24 or 23 to 24 could be carried out immediately after receipt of a response 12 for an identifier idᵢ if this takes place so quickly in terms of data processing that this can be done between consecutively arriving responses 12. It should be noted in this regard that, according to some DSRC standards, the responses 12 of several OBUs 15 replying to one common wireless poll 11 are variably spread over time so as to prevent collisions of responses 12, whereby sufficient time can remain between individual responses 12 for steps 22 to 24 or 23 to 24.

A parking beacon 7, the coverage range 10 of which covers several parking spaces 4, at the same time receives a complete overview of the occupancy status of the parking spaces 4 in its parking area P as a result of the responses 12 of the OBUs 5 in step 20. For this purpose, the beacon only needs to compare the number of identifiers idᵢ received in step 20 to the number of parking spaces 4 in the area P, so as to obtain a proportional or percentage-based utilization rate of the parking spaces 4, for example “80%” if 4 out of 5 parking spaces are occupied, and so forth. The parking space occupancy status thus determined can be sent to a central facility for parking area management measures, for example.

FIG. 7 shows a first part of the method for electronically processing traffic violations based on a control scenario, in which a control person 31 checks a vehicle 1 comprising the OBU 5 thereof with the aid of a transportable beacon 32, which is implemented as a handheld device, for example. In the example shown, the vehicle 1 is parked in a parking space 4. The parking mode PM was set by the user in the OBU 5, which is to say the status st in the memory 15 of the OBU 5 is accordingly set to “PM”. With the aid of the OBU 5 and one of the described parking beacons 7, for example, corresponding parking fee transactions to are generated, as was described based on FIGS. 1 to 6.

The control person 31 now carries out a road traffic check with the aid of the beacon 32. In the illustrated example, this person checks the correct setting of the parking mode PM in the OBU 5.

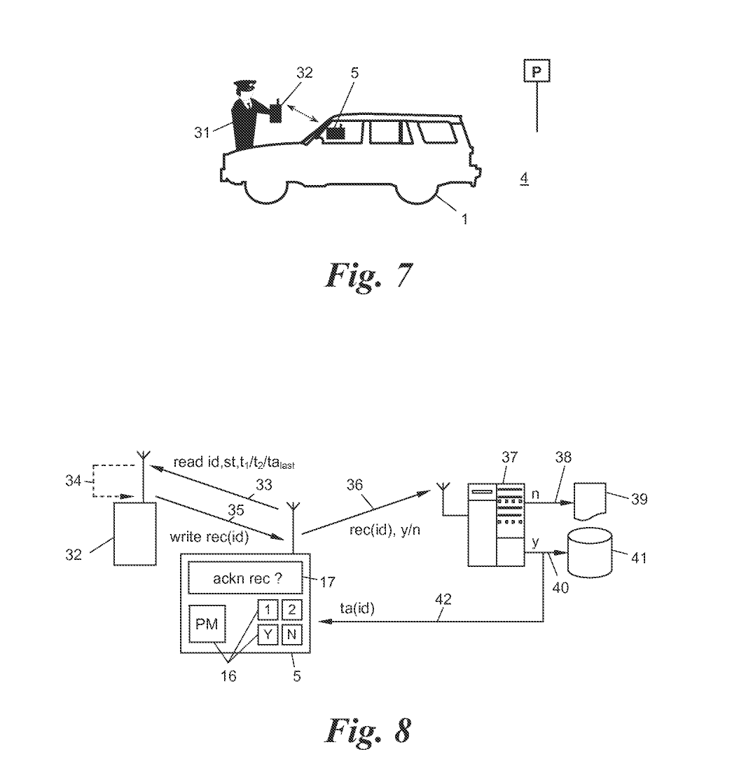

As is shown in FIG. 8, for this purpose in a first step 33 the identifier id and (optionally) the status st of the OBU 5 of the checked vehicle 1 are read out into the beacon 32 via a communication 8. Optionally, additional data such as the starting time t₁ of a parking process (time at which the parking mode PM is entered), the maximum allowed parking duration at this location in the form of a time window or an allowed ending time t₂, one or more of the last parking fee transactions taₗₐₛₜ processed in the OBU 5, traffic violation messages that were previously stored in the OBU 5 or the like, can also be read out.

Depending on the information received in the beacon 32, for example whether the status st in a parking space 4 was set correctly to “PM” by the user, a traffic violation message rec is compiled in a step 34 based on a visual comparison by the control person 31—or also in a partially or entirely automated fashion directly by the beacon 32, if it has appropriate sensors. If the beacon 32 carries out step 34 autonomously, instead of being a handheld device, it can also be set up in a stationary manner, for example, or carried by a patrol vehicle. It is also possible for the beacon 32 to be implemented in the form of one of the beacons 6 or 7 and to generate traffic violation messages rec, for example in the case of speed limit violations, parking time violations in a short-term parking zone or no-stopping zones with time limits and the like.

Thereafter, in a step 35, the traffic violation message rec is transmitted in a communication 8 to the OBU 5, where the message is output on the output device 17 to the user of the vehicle 1, for example via voice output or graphic display. Using the input device 16, for example voice input or the keyboard, the user of the vehicle 1 can now accept (“y”), or not accept (“n”), the traffic violation for payment and make a corresponding user selection y/n. On a supplementary basis, in the case of acceptance “y”, additionally a PIN code may be requested to be entered so as to further increase the payment security, for example so as to prevent third-party selection in the case of open convertibles or by vehicle users in rental cars who are not authorized to access the account.

For example, if the input and output devices 16, 17 are configured as a smartphone with an NFC connection, the violation can be accepted and a payment process can be triggered simply by the smartphone approaching the processor part of the OBU 5.

In a step 36 then, the user selection y/n is transmitted via the transceiver 13—or another transceiver of the OBU 5, for example a mobile communication module or via WAVE/LAN access of the distributed beacons—to a remote central facility 37 together with the traffic violation message rec and the identifier id of the OBU 5. The central facility 37 can take on any arbitrary form, for example a central facility of a road toll system, parking fee billing system, a bank computer, a credit card account processor and the like, which is connected wirelessly or by wire to one of the beacons 6, 7 and/or 32. The central facility 37 can even be directly implemented by one of the beacons 6, 7 or 32.

If the user selection y/n related to the declination of the indicated traffic violation (“n”), in a step 38 thereafter a “conventional” ticket 39 is created from the traffic violation message rec(id), for example it is printed out and mailed to the user of the vehicle 1 together a notice of the legal remedies that are available.

During the transmission of the user selection y/n in step 30, the authenticity of the user can optionally be checked by additionally transmitting a cryptographic OBU signature that is stored in the OBU 5 and/or the OBU 5 can sign and/or encrypt the user selection y/n and/or the traffic violation message rec(id) with the OBU signature and/or an OBU key. In this way, datasets of the user interaction that hold up in court can be generated.

If the user selection y/n related to the acceptance of the traffic violation (“y”), in step 40 a debit transaction ta(id) is generated from the traffic violation message rec(id) and charged against a user account 41, for example by debiting the user account 41 with a fine indicated in the traffic violation message rec(id). Alternatively or additionally, in step 42 the debit transaction ta(id) can also be returned to the OBU 5 via a communication 8 and charged there against a user account (an “electronic wallet”) kept directly in the OBU 5. The user account 41 could also be kept in a part of the input and output device 16, 17, for example if the same is implemented by a mobile terminal such as mobile telephone, smartphone, PDA, tablet PC or the like connected wirelessly, for example via NFC, Bluetooth® or the like. In this case, the OBU 5 can be programmed so that an appropriate message is sent to this wirelessly connected part of the input and output device 16, 17 for debiting the user account 41 and there, for example, a user account 41 in this terminal is debited or the debit transaction ta(id) is forwarded by the latter, for example to a billing center of a mobile communication network.

Alternatively, it is possible for the debit transaction ta(id) to be generated directly in the OBU 5 from the traffic violation message rec(id) and charged against a user account 41 kept in the OBU 5, in which case step 36, this being the forwarding of the traffic violation message rec(id), only becomes necessary if the traffic violation is declined (“n”); or a debit transaction to (id) that is directly generated in the OBU 5 is transmitted to the central facility 37 for processing in step 36—instead of the violation message rec(id).

If after an extended period, for example one month, the user has not entered a user selection y/n, the user selection y/n can be set to a predetermined value directly by the OBU 5 and can be further processed accordingly. The user selection may be set to the value “n” so as to not to debit an incorrect account or cause an early expiration of a deadline in the case of a ticket.

After the user selection y/n has been entered into the OBU 5, the traffic violation message rec(id) in the OBU 5 is deleted or marked as processed.

### CONCLUSION

The invention is not limited to the shown embodiments, but encompasses all variants and modifications that are covered by the scope of the accompanying claims. While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the described embodiments should not be limited by any of the above-described exemplary embodiments, but should be defined only in accordance with the following claims and their equivalents.

What is claimed is:

1. A method for electronically processing a traffic violation of a vehicle which has an onboard unit having a transceiver, an input device and an output device, comprising:
receiving a traffic violation message from a beacon at the transceiver of the onboard unit and outputting the traffic violation message on the output device of the onboard unit;
accepting a user selection related to two options via the input device of the onboard unit; and
if the user selection indicates the first option, transmitting the traffic violation message from the onboard unit to a remote central facility, or
if the user selection indicates the second option, generating a debit transaction related to the traffic violation and charging the debit transaction against a user account.

2. The method according to claim 1, wherein the user selection must be confirmed by entering a PIN code.

3. The method according to claim 1, wherein a cryptographic signature of the onboard unit is transmitted together with the traffic violation message.

4. The method according to claim 1, wherein the onboard unit signs and/or encrypts the traffic violation message with a cryptographic signature.

5. The method according to claim 1, wherein the user selection takes place by way of an NFC (near field communication) connection in the input device.

6. The method according to claim 1, wherein the user account is kept in the onboard unit and the debit transaction is generated in the onboard unit.

7. The method according to claim 1, wherein the user account is kept on a data carrier, which is debited via an NFC (near field communication) connection.

8. The method according to claim 1, wherein the user account is kept in the central facility, and the traffic violation message is transmitted together with the user selection to the central facility, where the debit transaction is generated.

9. The method according to claim 1, wherein the user account is kept in the central facility and the debit transaction is generated in the onboard unit and transmitted to the central facility.

10. The method according to claim 1, characterized by the preceding step of transmitting a status of the onboard unit to the beacon and creating the traffic violation message in the beacon depending on the received status.

11. The method according to claim 1, wherein the communication between the beacon and the onboard unit takes place according to the (dedicated short range communication) DSRC standard.

12. An onboard unit for a vehicle, comprising a transceiver, an input device and an output device, wherein the onboard unit is configured:
to receive a traffic violation message from a beacon and output it on the output device;
to accept a user selection concerning two options via the input device;
to transmit the traffic violation message to a remote central facility if the user selection indicates the first option; and
to initiate the generation of a debit transaction for a user account related to the traffic violation if the user selection indicates the second option.

13. The onboard unit according to claim 12, wherein the onboard unit comprises a stored modifiable status and is configured to transmit the status via the transceiver to the beacon in response to a wireless poll.

14. The onboard unit according to claim 12, wherein the onboard unit is configured to keep a user account and charge the debit transaction against the same.

15. The onboard unit according to claim 12, wherein the transceiver is a DSRC (dedicated short range communication) transceiver.

16. The onboard unit according to claim 12, wherein the user selection must be confirmed by entering a PIN code.

17. The onboard unit according to claim 12, wherein a cryptographic signature of the onboard unit is transmitted together with the traffic violation message.

18. The onboard unit according to claim 12, wherein the onboard unit signs and/or encrypts the traffic violation message with a cryptographic signature.

19. The onboard unit according to claim 12, wherein the user selection takes place by way of an NFC (near field communication) connection in the input device.

20. The onboard unit according to claim 12, wherein the user account is kept on a data carrier that is debited via an NFC (near field communication) connection, or is kept in the central facility and the traffic violation message is transmitted together with the user selection to the central facility where the debit transaction is generated.
